(19) United States
(12) Patent Application Publication
(10) Pub. No.: US 2006/0070459 A1
(43) Pub. Date: Apr. 6, 2006

(54) Tool with signal generator

(76) Inventor: Achim Kugler, Gschwend (DE)

Correspondence Address: STRIKER, STRIKER & STENBY, 103 EAST NECK ROAD, HUNTINGTON, NY, 11743, US

(21) Appl. No.: 11/236,780

(22) Filed: Sep. 27, 2005

(30) Foreign Application Priority Data
Sep. 29, 2004 (DE) 10 2004 047 232.7

(51) Int. Cl. B25B 23/145

(52) U.S. Cl. 73/862.21; 173/20

(57) ABSTRACT

A tool has a tool part for producing a connection, and a signal generator generating a signal such that the tool part gives an operator a response signal regarding a progress of a work procedure, which response signal can be of acoustic nature and/or a tactile nature, and indicating a completed work procedure or completed parts of the work procedure, wherein the signal generator is arranged on the tool part or contained inside the tool part.

### BACKGROUND OF THE INVENTION

The present invention relates to the general class of tools for producing detachable or nondetachable connections.

As a rule, visual displays are used to furnish tool operators with information about the current state of the work procedure being performed with the tool. For example, there are screwdrivers currently on the market that have red and green lights on the circumference of their housing in order to signal a result of the screw driving procedure.

The operator must therefore keep the tool constantly in view in order to correctly register the transmitted information. Frequently, however, operators are distracted and do not correctly understand the signal transmitted, are irritated by the jolt of the tool switching off, and wrongly assume that the screw has been correctly tightened. This can also be caused by distraction or inattention and consequently, not every screw connection is tightened to the correct torque. The dangerous result: insufficiently secured connections, e.g. wheels of commercial or passenger vehicles.

### SUMMARY OF THE INVENTION

The object of the present invention, therefore, is to find a method for a tool, which reduces error frequency in the operation of the tool and in the production of the connection by means of the tool.

In keeping with these objects and with others which will become apparent hereinafter, one feature of the present invention resides, briefly stated, in a tool, comprising a tool part for producing a connection; signal generator generating a signal such that said tool part gives an operator a response signal regarding a progress of a work procedure, with said response signal being of a nature selected from the group consisting of an acoustic nature, a tactile nature, and both and indicating a completed work procedure or completed parts of the work procedure, said signal generator being arranged in a position from the group consisting of being situated on said tool part and being contained inside said tool part.

When the tool is designed in accordance with the present invention the tool sends a response signal of an acoustic and/or tactile nature and this response signal indicates completion of a work procedure or only parts of the work procedure, wherein the signal generator is situated on the tool or contained inside it.

In a completely general sense, the tool can be any type of industrial tool used by an operator. Even when distracted, the operator is reliably furnished with information about the work procedure. For example, the work procedure can be a simple screw driving procedure in which a screw is to be tightened to a predetermined torque. The response signal is only activated if the required torque has been achieved so that only then does the operator detach the tool from the screw and move on to the next connection. The acoustic and/or tactile transmission of information thus assures that the operator or worker promptly receives the required information even when not in visual contact with the tool. This drastically reduces error sources based on distraction or inattention.

Another particular advantage is the possibility of indicating not only completed work procedures, but also partial steps within a work procedure. For example, it would therefore be conceivable to associate different signal patterns with different torques. It is possible to use acoustic and/or tactile signal generators either in combination or separately. Preferably, however, tactile signal generators should be used in order to minimize the noise level and accompanying irritations, for example when used in an assembly shop. Moreover, the operator is better able to associate a tactile signal directly with his own tool. Naturally, any conceivable combination of signal generators is possible, for example an optical plus a tactile plus an acoustic signal generator.

Preferably, in accordance with the present invention the signal generator delivers a pulsating signal. This is more effective than a continuous, uniform signal and is also easier to locate.

It is particularly preferable if one has the option to change the characteristic signal values of the signal generated by the signal generator. In particular, this changeability relates to the frequency, intensity, periodicity, signal spectrum (interference), and phase position. This offers the operator the option of individually composing a signal pattern that he finds the most noticeable. It is then possible to associate each work procedure or each part of the work procedure with its own signal characteristic.

It is particularly preferable for the vibration to be generated by a vibrator contained inside the tool. This vibration is transmitted to the tool housing and therefore to the operator's hands. It is generated within the tool being used and is thus only perceptible to the operator and does not bother anyone else.

Preferably, the vibration is generated by means of a modulation of the drive shaft, e.g. an imbalance imparted to a motor shaft. Consequently, a relatively inexpensive step provides an effective tactile response signal because the vibration is transmitted to the tool housing.

The present invention is particularly recommended for use in connection with a hand screwdriver since they have a relatively high error frequency, resulting in incorrectly tightened screws.

But even if the tool is a device for installing rivets, the present invention can accelerate the execution of work steps and reduce the number of error sources.

Even if the tool is a welding device or a part of a welding device, the present invention can be put to practical use monitoring the welding procedure and notifying the operator of the result of this monitoring. For example, the monitoring could include testing the welding point by introducing ultrasonic radiation as is frequently the case with resistance welding equipment.

It is particularly advantageous if the tool is constructed in modular fashion and the signal generator is embodied in the form of a module. It would then be possible to equip tools with signal generators of different types and capacities and to exchange them as necessary. For example, an acoustic signal generator can be used in an environment in which there are no requirements for noise protection, while a module with tactile and/or optical signal transmission is used in a noise-sensitive environment.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 of the drawings is a view showing a tool with a signal generator in accordance with the present invention.

### DESCRIPTION OF THE PREFERRED EMBODIMENTS

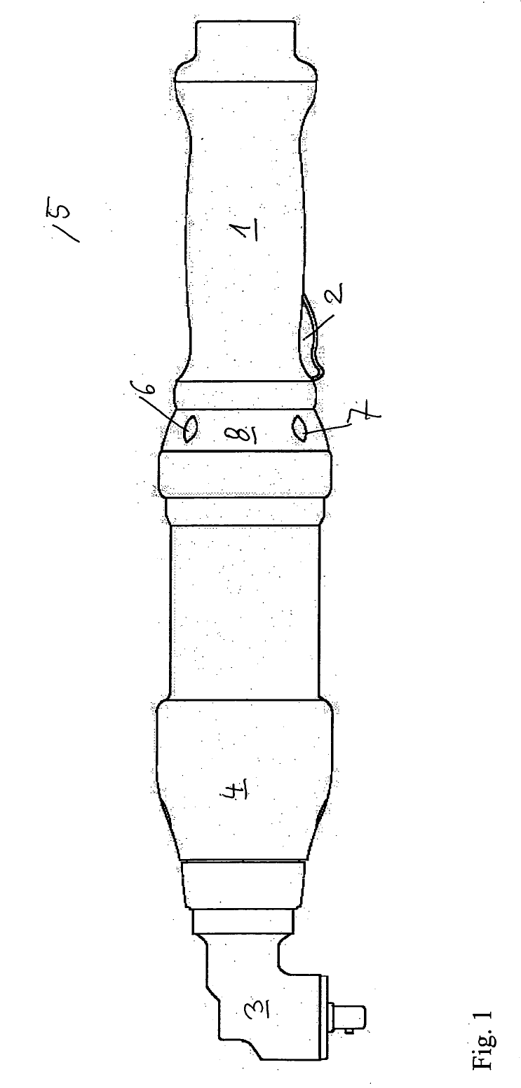

FIG. 1 shows an electric hand screwdriver 5 as an exemplary embodiment form of the current invention. The hand screwdriver 5 has a handle 1, an actuating lever 2, an output 3, and a housing 4 on which the output 3 is situated, oriented at right angles. The drawing also shows two lights 6, 7 on a middle part 8.

The tool is a screwdriver 5 with light signal generators formed by the lights. The housing 4 and/or handle 1 of the tool also contains a device for generating an acoustic and/or tactile response signal that makes it possible to signal a completed screw driving procedure or completed parts of a screw driving procedure. If the red light 6 comes on, this indicates that the work procedure is not yet complete. If the green light 7 comes on, this indicates that the work procedure has been completed.

The acoustic and tactile signal generator in the housing 4 generates a pulsating signal whose characteristic signal values can be set by the operator. The tactile signal, for example in the form of a vibration, is transmitted to the housing 4 of the tool 5 and therefore also to the handle 1 and the operators hand. The operator can set which work procedure should be signaled with which signal parameters. In particular, it is possible to vary and specifically associate the frequency, intensity, periodicity, spectrum, phase position, and duration of the signal.

The hand screwdriver 5 could be designed in modular fashion, i.e. the handle 1, the middle part 5, the housing 4, and the angled head 3 could be separate parts that can be plugged into one another. For example, it would then be possible for the middle part 8 to be designed so that it can include different types or combinations of signal generators and be attached to the housing 4 as a function of the respective use, environment, and requirements.

It would also be conceivable for the middle part 8 to be comprised of several parts, each part being associated with a different type of signaling (optical, acoustic, tactile) and for these parts to be attached to the housing of the tool 5 as needed. It is thus possible to freely configure the hand screwdriver 5 to the place in which is used.

It will be understood that each of the elements described above, or two or more together, may also find a useful application in other types of constructions differing from the types described above.

While the invention has been illustrated and described as embodied in a tool with signal generator, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims.

1. A tool, comprising a tool part for producing a connection; a signal generator generating a signal such that said tool part gives an operator a response signal regarding a progress of a work procedure, with said response signal being of a nature selected from the group consisting of an acoustic nature, a tactile nature, and both, and indicating a completed work procedure or completed parts of the work procedure, said signal generator being arranged in a position selected from the group consisting of being situated on said tool part and being contained inside said tool part.

2. A tool as defined in claim 1, wherein said signal generator is formed so that it generates the signal which is a pulsating signal.

3. A tool as defined in claim 1, wherein said signal generator is formed so that characteristic signal values of the signal generated by the signal generator are changeable.

4. A tool as defined in claim 1, wherein said generator is configured as a tactile signal generator in form of a vibrator.

5. A tool as defined in claim 4, wherein said signal generator is formed so that vibration is generated by a modulation via a drive motor shaft of said tool part.

6. A tool as defined in claim 1, wherein said tool part is configured as a hand screwdriver so that the connection is produced is a screw connection.

7. A tool as defined in claim 1, wherein said tool part is configured as a device for installing rivets so that the connection is produced as a rivet connection

8. A tool as defined in claim 1, wherein said tool part is an element selected from the group consisting of a welding device and a part of the welding device so that the connection is produced as a weld.

9. A tool as defined in claim 1, wherein said tool part is configured as a moduler tool part, while said signal generated is configured as a pluggable module.
